(19) United States
(12) Patent Application Publication
(10) Pub. No.: US 2006/0184541 A1
(43) Pub. Date: Aug. 17, 2006

(54) INTERNET CONNECTION APPARATUS AND METHOD OF NAVIGATION SYSTEM

(76) Inventor: DOO YOUL KIM, Icheon-shi Kyungki-do (KR)

Correspondence Address: IPLA P.A., 3580 WILSHIRE BLVD., 17TH FLOOR, LOS ANGELES, CA, 90010, US

(21) Appl. No.: 11/306,020

(22) Filed: Dec. 14, 2005

(30) Foreign Application Priority Data
Jan. 31, 2005 (KR) 10-2005-0008575

(51) Int. Cl. G06F 17/30

(52) U.S. Cl. 707/10

(57) ABSTRACT

An Internet connection apparatus and method of a navigation system including a communication unit and a global positioning system module is provided. The Internet connection apparatus includes: a map database for storing a map and map data having icons and names of peripheral facilities and areas and having a URL (universal resource locator) mapped to each of the icons and the names; a touch screen for receiving and displaying the map data, displaying a mouse cursor, and generating position data on a screen touched by a user; an input unit having a mouse for moving the mouse cursor, and generating coordinate data depending on the movement of the mouse cursor; and a controller for connecting to an Internet network, displaying a Web browser on the display unit, and displaying a homepage of the URL on the Web browser.

### BACKGROUND OF THE INVENTION

1. Field of the Invention

The present invention relates to a navigation system, and more particularly, to an Internet connection apparatus and method of a navigation system, which is capable of connecting to Internet to search for information on peripheral facilities displayed on a map screen while road guidance is executed through the navigation system.

2. Description of the Related Art

At present, a wireless Internet service with a wireless communication network and an Internet network coupled is being provided, a mobile communication terminal, that is, a terminal such as a cellular phone and portable digital assistants (PDA) is being put on a market, and a telematics terminal of a telematics system under standardization also will provide a wireless Internet service.

As such a wireless Internet technology, there are a wireless application protocol (WAP) for effectively transmitting data provided from a contents provider (CP) between the mobile communication terminal and a base station, and a wireless Internet platform interoperability (WIPI) being a standard installed in the mobile communication terminal and necessary for providing an execution environment of an application program downloaded through a wireless Internet. This technology is widely known to those skilled in the art and therefore, its detailed description will be omitted.

As described above, even in a running car with a wireless Internet environment established, the Internet can be executed. Accordingly, the wireless Internet environment is being requiring various additional devices and services.

### SUMMARY OF THE INVENTION

Accordingly, the present invention is directed to an Internet connection apparatus and method of a navigation system that substantially overcomes one or more of the limitations and disadvantages of the conventional art.

One object of the present invention is to provide an Internet connection apparatus and method of a navigation system, which is capable of connecting to Internet to search for information on peripheral facilities displayed on a map screen while road guidance is executed through the navigation system.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims as well as the appended drawings.

To achieve the above and other objects and advantages, and in accordance with the purpose of the invention, as embodied and broadly described herein, there is provided an Internet connection apparatus of a navigation system which has a communication unit connected to an Internet network through a wireless communication network, and has a global positioning system module having a direction sensor and a speed sensor to perform a navigation operation, the module receiving position signals from a plurality of satellites to calculate a current position and outputting position information including the calculated position, a direction, and a speed, the apparatus including: a map database for storing a map and map data having icons and names of peripheral facilities and areas mapped to the map and having a URL (universal resource locator) mapped to each of the icons and the names; a touch screen for, under a predetermined control, receiving and displaying the map data where a self position based on the position information is mapped, displaying a mouse cursor, and generating position data on a screen touched by a user; an input unit having a mouse for moving the mouse cursor, and generating coordinate data depending on the movement of the mouse cursor; and a controller for, in case where the coordinate data is positioned for the icon and the name on the map displayed on the display unit, when the URL is mapped to the icon or the name, connecting to the Internet network through the communication unit, displaying a Web browser on the display unit, and displaying a homepage of the URL on the Web browser.

In another aspect of the present invention, there is provided Internet connection method of a navigation system which has a communication unit connected to an Internet network through a wireless communication network; a map database for storing a map and map data having icons and names of peripheral facilities and areas mapped to the map and having a URL (universal resource locator) mapped to each of the icons and the names; a global positioning system module having a direction sensor and a speed sensor, and receiving position signals from a plurality of satellites to calculate a current position, and outputting position information including the calculated position, a direction, and a speed; a storage unit for storing a cursor, a Web browser, and an address of an Internet search site; and a display unit for displaying the map data and the cursor, and performs a navigation operation, the method including the steps of: in a navigation mode, determining whether or not to receive a command for searching an Internet search site; and upon receipt of the searching command, receiving an Internet search input data, driving the Web browser, connecting to the predetermined Internet search site, and searching for the Internet search input data.

It is to be understood that both the foregoing summary and the following detailed description of the present invention are merely exemplary and intended for explanatory purposes only.

### BRIEF DESCRIPTION OF THE DRAWINGS

The accompanying drawings, which are included to aid in understanding the invention and are incorporated into and constitute a part of this application, illustrate embodiment(s) of the invention and together with the description serve to explain the principles of the invention. In the drawings:

FIG. 1 illustrates a construction a wireless application protocol network according to the present invention;

FIG. 2 illustrates a construction of an Internet connection apparatus of a navigation system according to the present invention;

FIG. 3 is a flowchart illustrating an Internet connection method of an Internet connection apparatus of a navigation system according to the first embodiment of the present invention;

FIG. 4 is a flowchart illustrating a method of searching for Internet information using a navigation search window of a navigation system according to the second embodiment of the present invention;

FIG. 5 illustrates a screen configuration of an Internet connection apparatus of a navigation system according to an embodiment of the present invention;

FIG. 6 illustrates a method of searching for Internet information using a search menu window of a navigation system according to the third embodiment of the present invention; and

FIG. 7 illustrates an example of an Internet connection method using a display unit of a navigation system according to the fourth embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numerals will be used throughout the drawings to refer to the same or like parts.

In the present invention, there is provided an apparatus and a method in which there is provided a communication module for performing a data communication with an Internet network based on wireless application protocol (WAP) for wireless Internet service, and a global positioning system (GPS) module for receiving position signals from a plurality of satellites and map data through mapping of a map and a universal resource locator (URL) corresponding to each of icons and names for facilities, such as a building, a geographical name, a historic site, and a park, displayed at corresponding positions on the map, and calculating a current position from the position signals, and in road guidance, when a cursor is positioned on map facilities displayed on a screen, the cursor is changed in shape or the URL of the corresponding facility is displayed, and upon clicking in this state, connection is made to the corresponding URL.

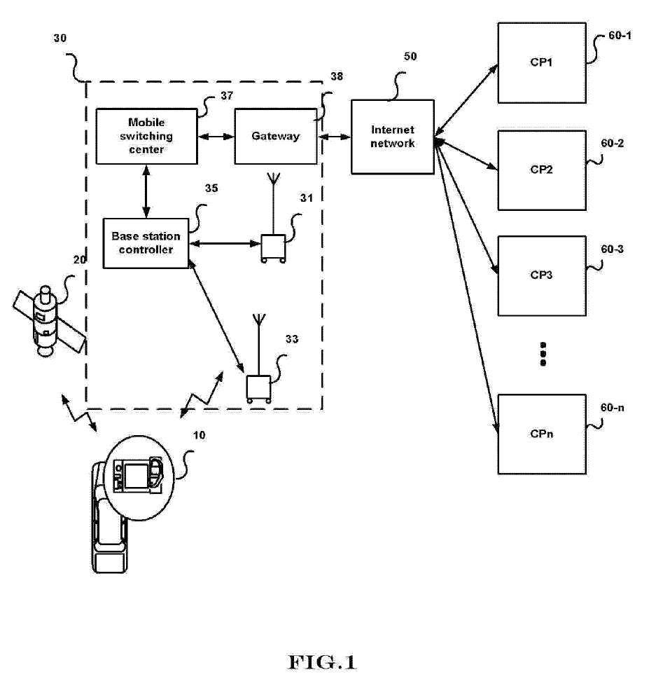

FIG. 1 illustrates a construction a wireless application protocol network according to the present invention.

Referring to FIG. 1, a reference numeral 10 denotes a navigation terminal, 30 denotes a wireless communication network, 50 denotes an Internet network, and 60 denotes a contents provider (CP), that is, an Internet-based information provider server.

The navigation terminal 10 receives the position signals from at least three satellites 30, calculates a self position, maps the calculated position to the map data, and displays the mapped position. In the present invention, the navigation terminal 10 performs wireless communication through the wireless communication network 30, connects with the Internet network 50, and provides an Internet service. Specifically, the navigation terminal 10 maps the universal resource locator (URL) registered to the Internet to each of the icons and names for the peripheral facilities on a map displayed on a screen during a navigation operation, that is, during execution of the road guidance. Accordingly, when the icon and name having the URL mapped are clicked with a mouse pointer, connection is made to the CP 60 of the URL mapped to the clicked icon and name, that is, to a homepage through the wireless communication network 38 and the Internet network 50.

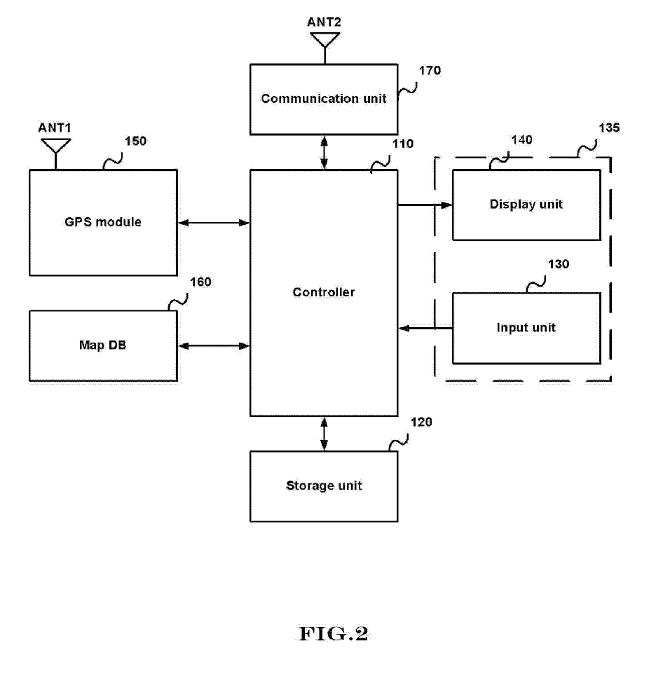

The mobile communication network 30 has a wireless application protocol applied. The mobile communication network 30 includes a plurality of base stations 31 and 33 wireless connecting with a cellular phone, a portable digital assistant (PDA) having a wireless communication function, and a telematics terminal; a base station controller 35 for controlling a resource management and an operation with the base stations; and a mobile switching center (MSC) 37 for connecting with other communication networks or forming a connection point for communication with other mobile switching centers, and a gateway 38. The gateway 38 connects with the Internet network 50, converts hyper text mark-up language (HTML) into wireless mark-up language (WML) according to the wireless application protocol, provides the converted WML to the mobile switching center 37, receives WML from the mobile switching center, converts the received WML into HTML, and transmits the converted HTML to the Internet network 50. [Para 31]The description of FIG. 1 is centered on a network configuration for connecting to the Internet in the Internet connection apparatus of the navigation system according to the present invention. Hereinafter, FIG. 2 describes a construction of the Internet connection apparatus of the navigation system according to the present invention.

The inventive Internet connection apparatus includes a controller 110, a storage unit 120, an input unit 130, a display unit 140, a GPS module 150, a map database 160, and a communication unit 170.

The controller 110 controls a general operation for the navigation operation and specifically, controls an operation for Internet connection during the navigation operation according to the present invention.

The storage unit 120 includes a region for storing a management program for controlling the navigation operation and the Internet connection during the navigation operation, a region for temporarily storing data generated in execution of the management program, a user data region for storing user data such as Internet data, and a region for storing user's setup items through a navigation mode. The management program storage region includes Web browser based on the wireless application protocol, and includes image data on the cursor having various shapes. The management program storage region and the user region employ nonvolatile memories in which data is not erased even when a power source is turned off. The user region stores a path selection variable such as a national highway priority and an expressway priority in selection of a path, and the shortest distance, a map displaying time point variable for selecting whether to display the map in two dimensions or in three dimensions, and an Internet display control variable for selecting whether to control the display unit 140 with a navigation priority or an Internet priority in the Internet connection according to the present invention. In case where the navigation priority is selected, only when the Internet connection is made, the corresponding homepage is completely loaded, and user's confirmation input is made, the controller 110 displays the Web browser on the display unit 140 and displays a corresponding homepage on the Web browser. On the contrary, in case where the Internet priority is set, when a user inputs for the Internet connection, the controller 110 performs the Internet connection, drives the Web browser, and displays the corresponding homepage.

Under the control of the controller 110, the display unit 140 receives and displays the map data according to the navigation operation, displays the Internet browser, that is, the Web browser, and displays downloaded Internet data on the Web browser. Further, the display unit 140 displays the mouse icon in various shapes. In the embodiment of the present invention, as the WAP is applied, the Web browser should be capable of processing the WML.

The input unit 130 can employ a key input unit having a plurality of keys for a navigation function, the Internet connection, and control, or a touch pad displaying buttons corresponding to the keys on a partial region of the display unit 140, and placed consistently with the display unit 140 and generating coordinate data of the buttons pressed. In general, an integral combination of the touch pad and the display unit 140 is called touch screen 135. In FIG. 2, in case where the input unit 130 is the touch pad, the touch screen 135 including the display unit 140 and performing two functions of a display device and an input device is shown by a dotted line. The input unit 130 should include the mouse to enable the mouse icon displayed on the display unit 140. In the present invention, the mouse can employ a pointing stick and a cursor shifting touch pad. The mouse shifts the mouse icon, that is, the mouse cursor displayed on the display unit 140, and outputs the coordinate data on the displayed screen depending on the shifting of the mouse cursor, to the controller 110.

For user convenience, the touch screen 135 and the key input unit including the mouse could be also provided together.

The GPS module 150 includes a direction sensor, a speed sensor, and a GPS receiver. The GPS module 150 receives the position signal having time data and position data from satellites 20 of FIG. 1 through an antenna (ANT1), calculates the self-position, and generates and outputs position information to the controller 110. The position information has information on a position, a direction, and a speed.

The map database (DB) 160 stores the map, and the map data obtained by mapping graphics or icons and names of a building, a cultural site, the historic site, the park, and a road to the map by latitude and longitude. Particularly, in the present invention, the URL and summary information corresponding or related to each icon and name are mapped and stored. The URLs are provided only for the icons and names registered to the Internet.

The communication unit 170 wireless connects and communicates with a base station of a corresponding area of the wireless communication network 30 through an antenna (ANT2). In the present invention, the communication unit 170 employs a code division multiple access (CDMA) module, and performs the wireless communication with the base station according to the wireless application protocol.

In the above, the present invention describes a case where the wireless application protocol (WAP) is applied, but can be applied in any communication system capable of wireless connecting to the Internet.

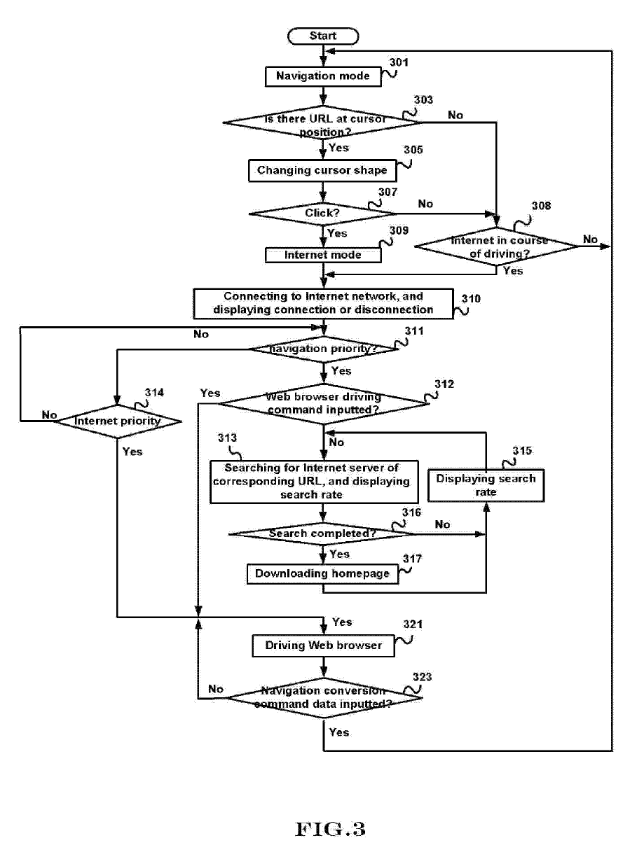

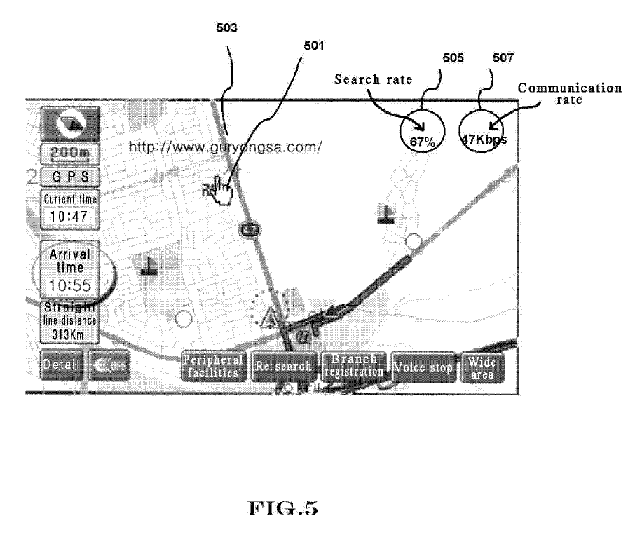

FIG. 3 is a flowchart illustrating an Internet connection method of an Internet connection apparatus of a navigation system according to the first embodiment of the present invention, and FIG. 5 illustrates a screen configuration of the Internet connection apparatus of the navigation system according to an embodiment of the present invention. Hereinafter, a description will be made with reference to FIGS. 1 t 3 and FIG. 5.

First, upon receipt of a navigation function key from the input unit 130, the controller 110 receives a destination, and executes the navigation mode in Step 301. In the navigation mode, the controller 110 receives the position information from the GPS module 150, selects the path by a predetermined path selection method with reference to the map data stored in the map database (DB) 160, maps the selected path, and map matches and displays the received position information on the display unit 140.

After the displaying of the map data in the Step 301, the controller 110 determines whether or not the cursor on the map screen is placed at the icon and name having the URL mapped in Step 303.

If the cursor is determined to be place at the icon and name in the Step 303, the controller 110 changes the cursor in shape in Step 305. For one example, in general, the cursor has an arrow-shape, and when the cursor is placed at the icon and name having the URL mapped, it can be changed to have a hand shape as shown by a reference numeral 501 of FIG. 5. However, in case where the cursor is placed at general regions other than the icon or the name, the controller 110 determines whether or not that the Internet is in course of driving in Step 308. If the Internet is determined not to be in course of driving in the Step 308, the Step 301 is continuously performed. However, if the Internet is determined to be in course of driving, the controller 110 displays Internet connection, and connection or disconnection in Step 310, and performs Step 311.

The above describes a case where the cursor is changed in shape but, when the cursor is placed at the icon and name having the URL mapped, the URL can be also displayed as shown by a reference numeral 503 of FIG. 5.

After the changing of the cursor shape in the Step 305, in Step 307, the controller 110 checks the input unit 130 and determines whether or not clicking is performed on the icon or the name on which the cursor is placed.

Upon clicking of the cursor in the Step 307, the controller 110 sets an Internet mode in Step 309. The Internet mode is a mode of setting a variety of set values for the Internet connection, that is, values such as a data communication rate. Upon completion of the setting of the Internet mode, in Step 310, the controller 110 attempts the Internet connection through the wireless communication network 30 via the communication unit 170, and displays Internet connection or disconnection on an upper portion of the display unit 140 as shown by a reference numeral 507 of FIG. 5. The reference numeral 507 of FIG. 5 illustrates a case where the Internet connection is activated and is at a rate of 47 Kbps. However, when the Internet connection is not activated, the 507 displays a message of “DISCONNECT” and shows that the Internet connection is not activated. [Para 49]After the Step 310, in the Steps 311 and 314, the controller 110 determines whether to set the Internet display control variable stored in the storage unit 120 to the Internet priority or the navigation priority. If the Internet display control variable is set to the Internet priority, the controller 110 directly drives and displays the Web browser on the display unit 140 in Step 321. If the Internet display control variable is set to the navigation priority, the controller 110 determines whether or not to receive a Web browser driving command in Step 312. The Web browser driving command is generated by a Web browser driving key when the key input device is used as the input unit 130, or by a Web browser driving button displayed on the touch screen when the touch screen 135 is used. For the Web browser driving button, a region 505 of FIG. 5 can be used. In other words, the region 505 not only displays a rate of Internet search but also is used for the Web browser driving button. Upon receipt of the Web browser driving command in the Step 312, the controller 110 drives the Web browser in the Step 321 and, otherwise, searches for the corresponding URL through the wireless communication network 30 and the Internet network 50 in Step 313. After the Step 313, the controller 110 determines whether or not a server having the URL, that is, the homepage is completely searched in Step 316. If the search is under process, in Step 315, the controller 110 updates a search rate for a percentage of completion of a current search, and displays the updated search rate at one side of the display unit 140.

Upon completion of the search, the controller 110 downloads the homepage of the searched URL in Step 317, and displays the search rate in the Step 315. At this time, the search rate will be 100%.

In other words, this means that, even though the search is completed and the homepage is completely downloaded, if the Web browser driving command is not inputted in the Step 312, the navigation mode is continuously enabled. This is to prevent the screen from changing differently from driver's intention while a driver is running a car.

If the Web browser is driven in the Step 321, the controller 110 displays the completely downloaded homepage through the Web browser. After that, the same subsequent operations as those of the general Internet are performed.

While the Internet is used, in Step 323, the controller 110 periodically determines whether or not to receive a navigation conversion command for converting the Internet mode into the navigation mode from the input unit 130. At this time, the Internet connection can be kept or disconnected.

The present invention can also set to continuously perform position track and voice guidance while using the Internet.

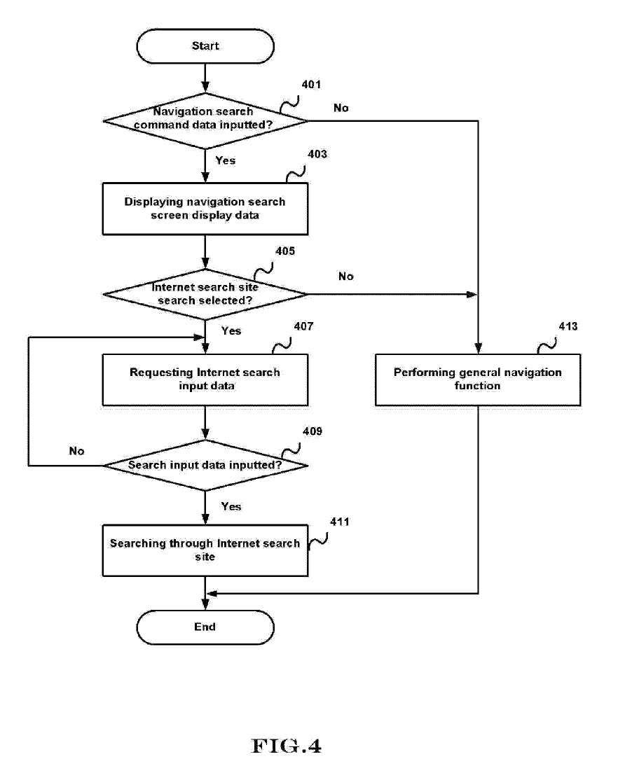

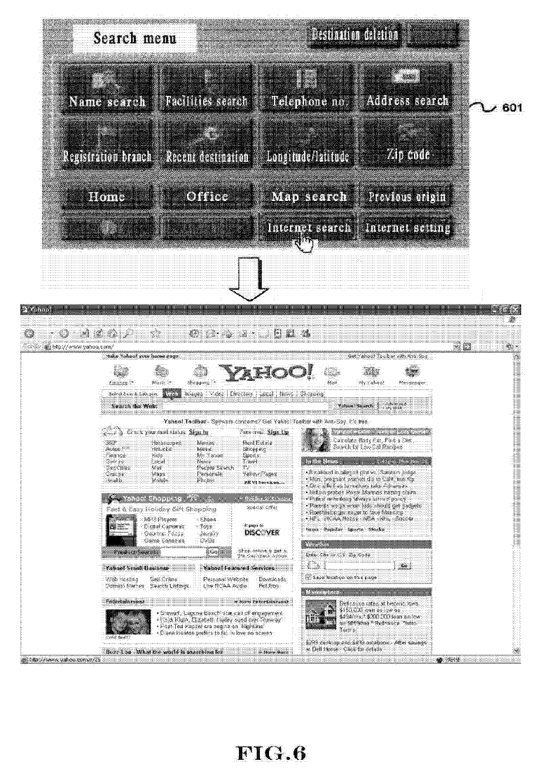

FIG. 4 is a flowchart illustrating a method of searching for Internet information using a navigation search window of a navigation system according to the second embodiment of the present invention, and FIG. 6 illustrates a method of searching for Internet information using a search menu window of a navigation system according to the third embodiment of the present invention. Hereinafter, an exemplary case of using the touch screen will be described with reference to FIGS. 1, 2, and 4.

The controller 110 determines whether or not a name search button for searching for the destination or an intermediate point is pressed on a search menu screen in Step 401. Upon pressing of the name search button in the Step 401, the controller 110 displays the name search screen on the display unit 140 in Step 403, and performs Step 405.

Upon selection of a search for an Internet search site in the Step 405, the controller 110 requests Internet search input data in Step 407. The request for the Internet search input data can be performed by flickering an underlined cursor in the search window of the name search screen or loading a separate new window.

After the request for the Internet search input data, the controller determines whether or not to receive the search input data in Step 409. Whether or not to receive the search input data can be determined by determining whether or not to receive Enter command input data representing completion of the search input data from the touch screen 135. The Enter command input data is generated by an enter button or an input button of the touch screen 135.

Upon reception of the search input data, in Step 411, the controller 110 displays the Internet search site on the Web browser, inputs the search input data in the search window, and enables search button data. If so, the search input data is transmitted to and searched in the Internet search site.

In a description of an example of searching for Children's Grand Park whose URL is not registered, when a user presses the name search key or button, the touch screen 135 generates and outputs name search command data to the controller 110. The controller 110 receives the name search command in the Step 401, and displays the name search screen in the Step 403. In case where the touch pad is used as the input device of the inventive Internet connection apparatus, an Internet search site search button is displayed on the navigation search screen. Upon selecting of the Internet search site search button or key in the navigation search screen, the controller 110 flicks the cursor in the search window of the name search screen, and requests to input the Internet search input data. If the user inputs the “Children's Grand park” and presses the Enter button or key or the search button or key, in the Step 409, the controller 110 detects the user's input and press, displays the predetermined corresponding Internet search site on the Web browser, and inputs the Internet search input data to the search window of the Internet search site and, in the Step 411, clicks the search button adjacent to the search window of the Internet search site, and performs the search. The search button of the search window of the Internet search site displayed on the Web browser has a coordinate value previously set when the Internet search site is registered and, in the Step 411, click data is generated by the coordinate value and transmitted to the Internet network, thereby executing the search.

Further, if the “Children's Grand Park” is inputted to the search window of the navigation search screen in the Step 403 and the search for the Internet search site is selected, the Step 411 can be directly performed and the search can be also performed.

Further, after the completion of the search, when any one of searched lists is selected, the controller 110 can inquire the user as to whether or not to set a URL of the selected site as a URL of the “Children's Grand Park” of the map data, and the user can select “OK” button or key and map the URL.

In another embodiment, as shown in FIG. 6, an Internet search button or key of a search menu window can be provided and the button or key can be pressed, thereby driving the Web browser and directly connecting to a preset Internet search site on the Web browser. In a detailed description, in Step 601, the controller 110 displays the search menu window, and determines whether or not the Internet search button is pressed on the search menu window. Upon pressing of the Internet search button of the search menu window in the Step 601, in Step 603, the controller 110 drives the Web browser, connects to the preset Internet search site, and displays the homepage of the search site on the Web browser.

In the above embodiment, in order to connect to the Internet search site, a URL of the Internet search site can be also preset or, when the Internet search button is pressed, a separate URL input window can be loaded and the URL can be inputted through the URL input window, thereby also performing the search. In the former, the URL of the Internet search site can be set using an Internet set button as shown in FIG. 6. Further, when the URL is set, the coordinate value of the search button that is put aside the search window of the homepage of the Internet search site can be previously set using the Internet set button.

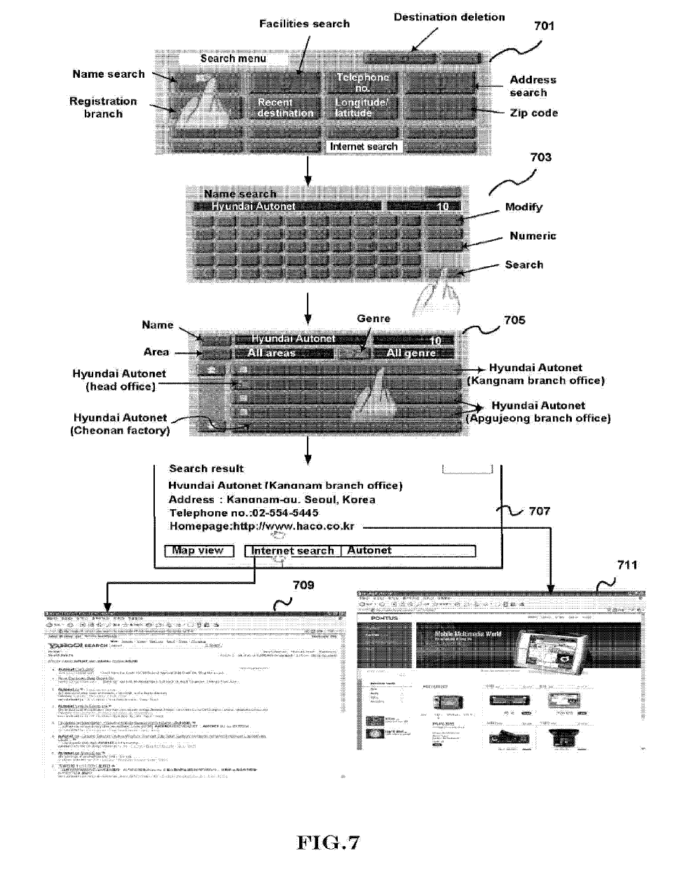

FIG. 7 illustrates an example of an Internet connection method using the display unit of the navigation system according to the fourth embodiment of the present invention.

Referring to FIG. 7, in Step 701, the controller 110 displays a search menu window on the touch screen 135, and determines whether or not to receive a name search button from the touch screen 135. Upon receipt of the name search button in the Step 701, in Step 703, the controller 110 displays the name search window. At this time, a user inputs a name to be searched, using alphanumeric input buttons. The controller 110 determines whether or not to receive an Enter or search button from the touch screen 135.

Upon receipt of the Enter or search button in the Step 703, the controller 110 displays search results in Step 705. After the displaying of the search results, the controller 110 determines whether or not one of the search results is selected. If one of the search results is selected, in Step 707, the controller 110 displays summary information having a URL linked to a Web browser for the selected search result as shown in a display screen of the Step 707 FIG. 7. For this, the storage 120 should have the summary information on each name.

After the displaying of the summary information, the controller 110 determines whether or not to click the Internet search button or the URL of the summary information. Upon clicking of the Internet search button, in Step 709, the controller 110 drives the Web browser, and displays the homepage of the preset Internet search site on the Web browser. On the contrary, upon clicking of the URL of the summary information or the name button, the controller 110 drives the Web browser, connects to the URL, and displays the homepage of the URL on the Web browser.

As described above, in Internet-related set values, as shown in FIG. 6, by pressing an Internet set button provided for the search menu window, Internet-related setting, that is, setting of the Internet search site and setting of the coordinate value of the search button put aside the search window of the homepage of the Internet search site can be made but, even in a navigation set menu window, that is, even in a navigation set menu mode, the Internet-related setting can be also performed. In detail, a variety of variables related to the navigation function are set in the navigation set menu mode. The navigation set menu mode is enabled through pressing a navigation set menu button or key on the uppermost menu. For example, as the navigation set menu mode, there are a path search method set mode for selecting items (variables), such as the expressway priority, the national highway priority, and the shortest distance, when the path is searched, and a map display time point selection mode for setting a display method of the map displayed on the screen, that is, whether the map is displayed in the two dimension or in the three dimension. Accordingly, even in the Internet-related setting according to the present invention, the Internet-related set button is displayed on the navigation set menu window and, when the Internet-related set button or key is pressed, the Internet-related set window is displayed and the Internet-related variables are set through the Internet-related set window.

As described above, the present invention has an advantage in that since the Internet connection can be made during the navigation operation, the driver is provided with a variety of information on an area where the car is running and therefore, the driver can be provided with a variety of knowledge, thereby enhancing driver's satisfaction.

While the present invention has been described with reference to exemplary embodiments thereof, it will be apparent to those skilled in the art that various modifications can be made therein without departing from the spirit and scope of the invention as defined by the appended claims and their equivalents.

What is claimed is:

1. An Internet connection apparatus of a navigation system which has a communication unit connected to an Internet network through a wireless communication network, and has a global positioning system module having a direction sensor and a speed sensor to perform a navigation operation, the module receiving position signals from a plurality of satellites to calculate a current position and outputting position information including the calculated position, a direction, and a speed, the apparatus comprising:
a map database for storing a map and map data having icons and names of peripheral facilities and areas mapped to the map and having a URL (universal resource locator) mapped to each of the icons and the names;
a display unit for, under a predetermined control, receiving and displaying the map data where a self-position based on the position information is mapped, and displaying a mouse cursor;
an input unit having a mouse for generating a Web browser driving command, moving the mouse cursor, and generating coordinate data depending on the movement of the mouse cursor; and
a controller for, in case where the coordinate data is positioned for the icon and the name on the map displayed on the display unit, when the URL is mapped to the icon or the name, connecting to the Internet network through the communication unit and, when the Web browser driving command is inputted, displaying a Web browser on the display unit and displaying a homepage of the URL on the Web browser.

2. The apparatus according to claim 1, wherein the controller displays Internet connection or disconnection on one region of a screen of the display unit.

3. The apparatus according to claim 1, wherein the controller displays a search rate of the URL on one region of the screen of the display unit.

4. The apparatus according to claim 2, wherein the controller displays a search rate of the URL on one region of the screen of the display unit.

5. The apparatus according to claim 3, wherein the input unit is a touch pad integrated with the display unit and outputting a coordinate value on the screen of the display unit.

6. The apparatus according to claim 4, wherein the input unit is a touch pad integrated with the display unit and outputting a coordinate value on the screen of the display unit.

7. The apparatus according to claim 5, wherein, when the search rate display region is pressed by a user, a coordinate value of the region is received and recognized as the Web browser driving command to drive the Web browser.

8. The apparatus according to claim 6, wherein, when the search rate display region is pressed by a user, a coordinate value of the region is received and recognized as the Web browser driving command to drive the Web browser.

9. An Internet connection apparatus of a navigation system which has a communication unit connected to an Internet network through a wireless communication network, and has a global positioning system module having a direction sensor and a speed sensor to perform a navigation operation, the module receiving position signals from a plurality of satellites to calculate a current position and outputting position information including the calculated position, a direction, and a speed, the apparatus comprising:
a map database for storing a map and map data having icons and names of peripheral facilities and areas mapped to the map and having a URL (universal resource locator) mapped to each of the icons and the names;
a touch screen for, under a predetermined control, receiving and displaying the map data where a self-position based on the position information is mapped, displaying a mouse cursor, and generating position data on a screen touched by a user;
an input unit having a mouse for moving the mouse cursor, and generating coordinate data depending on the movement of the mouse cursor; and
a controller for, in case where the coordinate data is positioned for the icon and the name on the map displayed on the display unit, when the URL is mapped to the icon or the name, connecting to the Internet network through the communication unit, displaying a Web browser on the display unit, and displaying a homepage of the URL on the Web browser.

10. The apparatus according to claim 9, wherein the controller displays Internet connection or disconnection on one region of a screen of the display unit.

11. The apparatus according to claim 9, wherein the controller displays a download rate of a homepage of the URL on one region of the screen of the display unit.

12. The apparatus according to claim 10, wherein the controller displays a download rate of a homepage of the URL on one region of the screen of the display unit.

13. The apparatus according to claim 11, wherein, after search is completed and the homepage is completely downloaded, upon receipt of coordinate data of the download rate display region, driving the Web browser and displaying the homepage on the Web browser.

14. The apparatus according to claim 12, wherein, after search is completed and the homepage is completely downloaded, upon receipt of coordinate data of the download rate display region, driving the Web browser and displaying the homepage on the Web browser.

15. An Internet connection method of a navigation system which has a communication unit connected to an Internet network through a wireless communication network; a map database for storing a map and map data having icons and names of peripheral facilities and areas mapped to the map and having a URL (universal resource locator) mapped to each of the icons and the names; a global positioning system module having a direction sensor and a speed sensor, and receiving position signals from a plurality of satellites to calculate a current position, and outputting position information including the calculated position, a direction, and a speed; a storage unit for storing the map data, a cursor Web browser, and image data; and a display unit for displaying the map data and a cursor, and performs a navigation operation, the method comprising the steps of:
in a navigation mode, determining whether or not the icon or name having a URL (universal resource locator) mapped is clicked by the cursor;
upon clicking of the icon or name having the URL mapped, setting to be in an Internet mode, and connecting to Internet through the communication unit; and
upon connecting to the Internet, driving a Web browser, downloading Internet data from a contents provider server of the clicked URL through the Web browser, and displaying the downloaded Internet data.

16. The method according to claim 15, further comprising the steps of: after the setting of the Internet mode, displaying Internet connection or disconnection.

17. The method according to claim 15, further comprising the step of: after the Internet connection, displaying a search rate of the clicked URL.

18. The method according to claim 16, further comprising the step of: after the Internet connection, displaying a search rate of the clicked URL.

19. The method according to claim 15, wherein, when the cursor is placed on the icon or name having the URL mapped, it changes in shape.

20. The method according to claim 15, wherein, when the cursor is placed on the icon or name having the URL mapped, the URL is displayed around the corresponding icon or name displayed on the display unit.

21. The method according to claim 16, wherein, when the cursor is placed on the icon or name having the URL mapped, the URL is displayed around the corresponding icon or name displayed on the display unit.

22. An Internet connection method of a navigation system which has a communication unit connected to an Internet network through a wireless communication network; a map database for storing a map and map data having icons and names of peripheral facilities and areas mapped to the map and having a URL (universal resource locator) mapped to each of the icons and the names; a global positioning system module having a direction sensor and a speed sensor, and receiving position signals from a plurality of satellites to calculate a current position, and outputting position information including the calculated position, a direction, and a speed; a storage unit for storing a cursor, a Web browser, and an address of an Internet search site; and a display unit for displaying the map data and the cursor, and performs a navigation operation, the method comprising the steps of:
in a navigation mode, determining whether or not to receive a command for searching an Internet search site; and
upon receipt of the searching command, receiving an Internet search input data, driving the Web browser, connecting to the predetermined Internet search site, and searching for the Internet search input data.
